(19) United States
(12) Patent Application Publication
(10) Pub. No.: US 2026/0017518 A1
(43) Pub. Date: Jan. 15, 2026

(54) METHOD AND DEVICE FOR EXTRACTING AN OPTIMAL NETWORK ARCHITECTURE FOR SOLVING THE TARGET TASK

(71) Applicant: Robert Bosch GmbH, Stuttgart (DE)

(72) Inventors: Abhash Kumar Jha, Freiburg Im Breisgau (DE); Arjun Krishnakumar, Freiburg Im Breisgau (DE); Benedikt Sebastian Staffler, Tuebingen (DE); Frank Hutter, Freiburg Im Breisgau (DE); Martin Rapp, Esslingen Am Neckar (DE)

(21) Appl. No.: 19/211,902

(22) Filed: May 19, 2025

(30) Foreign Application Priority Data
May 29, 2024 (DE) 10 2024 205 000.8

(51) Int. Cl. G06N 3/082; G06N 3/048

(52) U.S. Cl. CPC G06N 3/082; G06N 3/048

(57) ABSTRACT

A method for extracting an optimal network architecture for solving a target task. The method includes: providing a supermodel pre-trained based on labeled training data for solving the target task, wherein the supermodel includes a plurality of pre-trained operations; adding at least one LORA module to at least one of the operations of the supermodel, wherein the LORA modules in each case include trainable weights; training the pre-trained supermodel by training the respective weights of the relevant LORA module, until a certain training criterion is reached, wherein the at least one of the operations of the supermodel remains unchanged during the training of the weights; extracting an optimal network architecture for solving the target task from the trained supermodel based on the architecture weights; and providing the extracted optimal network architecture for solving the target task.

### FIELD

The present invention relates to a method for extracting an optimal network architecture for solving the target task. The present invention relates to a device for extracting an optimal network architecture for solving the target task.

### BACKGROUND INFORMATION

Neural architecture search (NAS) techniques address the problem of automatically discovering the architecture of a neural network in such a way that a certain performance of the neural network is maximized. Such a performance can, for example, be the performance of the neural network in solving a task, such as increasing the accuracy of an image classification task.

Differentiable neural architecture search (DARTS) addresses this problem by defining a supernet or supermodel in which each edge combines a plurality of alternative operations (e.g., 3×3 convolution, pooling, and/or skip connection). During training, DARTS jointly trains the relative importance of the individual alternative operations (architecture weights) and their trainable parameters (model weights). After training, the optimal architecture can then be ascertained from the architecture weights, e.g., by selecting the operation with the maximum architecture weighting.

DARTS therefore performs NAS by training a supermodel that is a superposition of different possible neural network operations oᵢ ∈0 at each edge, which are weighted by architecture weights αᵢ.

$$y = {\sum }_{i} \frac{{e}^{{α}_{i}}}{{\sum }_{j} {e}^{{α}_{i}}} {o}_{i} ( x )$$

Examples of operations oᵢ can be: 3×3 convolution, 5×5 convolution, skip connection, max pooling, etc. The goal of the search is to find the only optimal operation oᵢ per edge. This is achieved via a two-stage optimization process, where the weights of the operations oᵢ and the architecture weights αᵢ are alternately trained. After training, the operations are selected by selecting the k most important operations (k highest αᵢ values).

However, DARTS repeatedly exhibits malfunctions, since it has a strong tendency to perform trivial operations such as skip connections during extended training, in particular during extended training sessions. This leads to performance degradation and prevents an optimal architecture from being found.

A plurality of studies in the field of network search aim to mitigate the potential failures of DARTS. For example, approaches are available in which the training of the supermodel is stopped based on an analysis of the gradients of the architecture weights. In this way, the tendency towards trivial operations is mitigated. At the same time, stopping training also prevents further exploration of the search space in order to find better network architectures.

Other studies address the problem by adding a regularization term to the training loss in order to, for example, increase correlation between the architecture weights across all layers.

As a result, the DARTS error mode is indeed mitigated, but adding an additional regularization term leads to performance losses of the network and requires tuning of a relative weighting. The tuning can be computationally intensive, since a plurality of search procedures may need to be executed.

It is an object of the present invention to provide an improved method and/or device for extracting an optimal network architecture.

The object may be achieved by a method according to certain features of the present invention. The object is further achieved by a device according to certain features of the present invention.

### SUMMARY

According to a first aspect of the present invention, a method for extracting an optimal network architecture for solving a target task is provided. According to an example embodiment of the present invention, the method comprises the following steps:
Providing a supermodel pre-trained on the basis of labeled training data for solving the target task, wherein the supermodel comprises a plurality of pre-trained operations, each of which can be assigned at least one architecture weight;
Adding at least one LORA module to at least one of the operations of the supermodel, wherein the LORA modules in each case comprise trainable weights, wherein the at least one of the operations of the supermodel preferably remains unchanged or is frozen during the addition of the weights;
Training the pre-trained supermodel by training the respective weights of the relevant LORA module and the at least one of the operations in particular until a certain training criterion is reached;
Extracting an optimal network architecture for solving the target task from the trained supermodel on the basis of the preferably trained architecture weights; and
Providing the extracted optimal network architecture for solving the target task.

It is understood that the steps according to the present invention as well as other optional steps do not necessarily have to be carried out in the order shown, but can also be carried out in a different order. Other intermediate steps can also be provided. The individual steps can also comprise one or more sub-steps without departing from the scope of the method according to the present invention.

According to a second aspect of the present invention, a device for extracting an optimal network architecture for solving a target task is provided. According to an example embodiment of the present invention, the device includes an evaluation and computing unit that is designed to carry out the following steps:
Providing a supermodel pre-trained on the basis of labeled training data for solving the target task, wherein the supermodel comprises a plurality of pre-trained operations, each of which can be assigned at least one architecture weight;
Adding at least one LORA module to at least one of the operations of the supermodel, wherein the LoRA modules in each case comprise trainable weights, wherein the at least one of the operations of the supermodel preferably remains unchanged or is frozen during the addition of the weights;
Training the pre-trained supermodel by training the respective weights of the relevant LORA module and the at least one of the operations in particular until a certain training criterion is reached;
Extracting an optimal network architecture for solving the target task from the trained supermodel on the basis of the preferably trained architecture weights; and
Providing the extracted optimal network architecture for solving the target task.

Preferably, the relevant pre-trained operation of the supermodel is allocated or assigned at least one architecture weight.

The explanations given for the method of the present invention apply accordingly to the device of the present invention. It is understood that linguistic modifications of features formulated for the method can be reformulated for the device in accordance with standard linguistic practice, without such formulations having to be explicitly listed here.

How the operations of the supermodel are pre-trained is fundamentally arbitrary. The pre-training method can be, e.g., supervised, semi-supervised or unsupervised.

The target task can be, for example, classification and/or segmentation of image data. The target task can generally also comprise object recognition and/or semantic segmentation and/or semantic generation of data. A neural network or machine learning model underlying the optimized network architecture to be extracted is to be optimized to solve the target task as optimally as possible.

The training data can be labeled image and/or video data or text data or audio data or other data that can be identified or labeled.

After adding the LoRA modules, the operations are preferably “unfrozen” or can change again in order to be trainable again.

The supermodel or base model can be, purely by way of example, a CNN or a transformer, which can preferably be randomly initialized at the beginning, i.e., prior to the pre-training of the supermodel. The supermodel can comprise a plurality of nodes and/or edges in order to in each case generate an output from an input—also when viewed layer by layer. For generating the output from the input, preferably randomly selectable or presettable operations are available in each case.

Convolutional neural networks (CNNs) are specialized in processing data with a known, grid-like topology. Examples of such data are images (2D grids of pixels) and audio signals (1D grids of samples). A CNN uses a mathematical operation called convolution in order to extract features from these data. The convolutional layer in a CNN preferably uses filters that slide over the input image (or other type of input signal) in order to identify features such as edges, corners and other texture-based information. This filtered information is then processed by further layers, which typically consist of pooling layers (for reducing dimensionality), further convolutional layers and finally fully connected layers. Transformers are a class of models based on a mechanism called “self-attention,” which allows each piece of data to relate to every other piece. In contrast to CNNs, which process spatial hierarchies of features, transformers can identify dependencies across long distances in the data. Transformers do not have a recurrent structure (such as, e.g., LSTMs) and process all inputs simultaneously, which makes them particularly well-suited for parallel processing.

They include a plurality of layers of attention blocks and feedforward neural networks.

The method according to an example embodiment of the present invention is used in the context of the DARTS approach. The DARTS (Differentiable Architecture Search) approach uses the term “supermodel” (or “supernet”) in a specific context of architecture search for neural networks. In differential architecture search, a supermodel is designed to represent all possible architectures in a defined search space. This supermodel therefore comprises a wide range of architecture components and architecture configurations that are considered during the training process. The supermodel can comprise a plurality of network layers and connections, each of which is represented by a learnable weight or operation. These weights or operations determine the importance or contribution of each component to the final network architecture. In contrast to other architecture search methods, such as, e.g., those based on reinforcement learning or evolutionary algorithms, DARTS is fully differentiable. This means that the selection of architecture components can be optimized by gradient descent. In the DARTS method, the weights or operations of the network (the parameters of each layer) and the architecture parameters (which determine which layers and connections are used) are trained simultaneously. This makes it possible to find both the best architecture and the optimal parameters for that architecture at the same time.

The method of the present invention and the corresponding device of the present invention can be used for machine learning models or neural networks that are used with image data originating, for example, from a video camera and/or a radar sensor and/or a lidar sensor and/or an ultrasonic sensor and/or a motion sensor and/or a thermal sensor. The present method and the corresponding device can be used for machine learning models that work with audio data and/or text data. Based on the sensor signal, information about the elements encoded by the sensor signal can be obtained, i.e., an indirect measurement can be performed based on the sensor signal used as a direct measurement.

The present invention provides a method based on the analysis and processing of sensor data using artificial intelligence, especially using neural networks. The method and device are capable of performing a wide range of functions that can be used in various applications in order to improve efficiency and safety in technical and non-technical environments. The present invention can contribute to classifying sensor data efficiently and computationally, recognizing objects within these data and/or performing semantic segmentation. This is particularly useful for applications in the traffic sector, where, for example, the recognition and classification of traffic signs, road surfaces, pedestrians and vehicles are required. Through the computationally optimized analysis of low-level features in the present case such as edges or pixel attributes in images, the system makes the precise and reliable processing of visual data possible, while simultaneously reducing memory and computing requirements. Another important aspect of the present invention is the provision of computationally and memory-optimized machine learning models that can be used to perform regression analyses using video and audio analysis. Such a machine learning model system can determine continuous values, such as the distance, speed or acceleration of objects. These functions are important for autonomous driving and other applications where accurate measurement of dynamic variables is required. The technology also makes possible the tracking of specific elements or objects in the data based on the same low-level characteristics. This is essential for security and surveillance systems and for interactive applications where continuous object tracking is required. The present invention can help to recognize anomalies in technical systems in a computationally optimized manner. By optimizing neural network architectures, the system is capable of being used in various fields, in particular where advanced pattern recognition and data analysis are required. Finally, the present invention can also be used to control technical systems. It is capable of calculating and implementing control signals in order to control various systems, from robotic systems and vehicles to household appliances and medical imaging systems. This is done by measuring and analyzing data, typically from sensors, and then adapting and controlling the technical system according to the findings.

The method according to the present invention and the corresponding device of the present invention are located in an upstream part of the machine learning tool chain. The method of the present invention and the corresponding device of the present invention do not directly improve a machine learning model that can be used for the above-mentioned applications, but rather disclose a method and a corresponding device for training such a machine learning model or neural network, possibly including the learning of a strategy.

The method of the present invention and the corresponding device of the present invention provide a hardware-enabled auto-machine learning or neural network search (NAS). The present method and the corresponding device can use multi-objective search with respect to model performance (e.g., accuracy, etc.) and the hardware performance of the model (e.g., latency, FLOPS, power consumption, memory usage). For example, an additional loss term can be added to the loss function, wherein the additional loss term predicts the hardware performance according to architecture parameters. This can be based, for example, on the weighted number of FLOPs of the candidate operations. FLOPs, an acronym for “Floating Point Operations Per Second,” is a metric preferably used to evaluate the complexity and/or computational capacity of a neural network. It indicates how many floating-point operations (i.e., additions, subtractions, multiplications and divisions) a network can perform per second during its execution.

The method of the present invention and the corresponding device of the present invention improve DARTS in two respects. On the one hand, DARTS are improved by replacing the regular training of operations oᵢ with a LoRA approximation after a few training epochs. Furthermore, DARTS are improved by early pruning of the search space during training. In the present case, LORA is used here in order to minimize the failure modes of the DARTS approach through regularization.

The method of the present invention and the corresponding device of the present invention also use the Low Rank Adaptation (LoRA) method. LoRA makes fine-tuning of pre-trained models possible with limited resources. This is achieved by freezing the original weights, i.e., not calculating gradients, and introducing a (smaller) LoRA module that is trained. Since the original layer calculates an output y∈ [symbol] by multiplying an input x∈ [symbol] with weights W∈ [symbol] as follows:

$$y = Wx$$

LORA freezes the weights W and adds an additional term based on two trainable matrices A∈ [symbol] and B∈ [symbol] with k<<min(d, k):

$$y = Wx + BAx .$$

After training, LoRA further calculates an updated set of weights W′=W+BA for use during inference without any additional effort compared to the original model.

The design of the LORA modules preferably depends on the type of operations of the supernetwork. For example, if the supernetwork comprises dense or fully connected layers, a LoRA module can be added. For example, if the supernetwork comprises convolutional layers, a modified LORA module can be added. For example, if the supernetwork comprises operations that do not comprise trainable weights, no LoRA modules are added to these operations. This can be the case, for example, with pooling layers and/or skip connections. In a skip connection, an input corresponds to an output, i.e., it is not changed when the connection is passed through, but is only forwarded and/or redirected, for example.

A similar approach can also be applied to convolution operations, where changes to the kernel W∈ [symbol] are approximated by two low-rank matrices A∈ [symbol] and A∈ [symbol] , and the product BA∈ [symbol] is reshaped into the same form as W.

In a further aspect of the present invention, it is provided that the operations of the supermodel are pre-trained until a predetermined termination criterion is reached.

The pre-training of the supermodel or its operations on the basis of the labeled training data can, for example, be performed until a loss function that exists when solving the at least one target task and that is to be optimized meets a predetermined limit criterion. The pre-training of the supermodel can also be carried out until a predetermined number of training epochs, which can be considered as a termination criterion, is met. Other termination criteria are also possible.

In a further aspect of the present invention, it is provided that extracting the optimal network architecture from the trained supermodel on the basis of the trained architecture weights comprises selecting the operations that are allocated the highest architecture weights.

Preferably, the operations or operators from the supernetwork are selected per edge, to which the highest architecture weights have been assigned in each case. A hierarchical ordering of the operations together with the associated architecture weights can be carried out after training, wherein only a number N of the hierarchy of operations is selected per edge and/or per layer.

In a further aspect of the present invention, it is provided that the provided, extracted optimal network architecture is retrained on the basis of the labeled training data in order to solve the target task.

The retraining of the optimized network can be carried out on the basis of the same training data or on the basis of modified or extended training data.

In a further aspect of the present invention, it is provided that after extracting the optimal network architecture, the respective LORA modules and the respective operations are combined.

The integration of the LoRA module into the original process preferably depends on how the LORA modules are implemented. For dense layers, a new set of weights W′ is preferably calculated from the frozen weights W and the inner product of the weights B and A of the LoRA module:

$${W}^{′} = W + BA$$

In the case of convolution layers, a new kernel W′ is preferably calculated from the kernel of the original convolution and the inner product of the kernels B and A of the LoRA module:

$${W}^{′} = W + BA$$

In a further aspect of the present invention, it is provided that after training the weights of the LORA modules and the operations, a pruning of operations of the supermodel is carried out on the basis of the weights of the LORA modules.

Particularly preferably, in the present case a so-called early pruning of the search space is carried out, in which operations are hidden at an early stage of training if they are not given too great a weighting with respect to the LORA weights. The inventors have realized that operations that are recognized as not weighty at an early stage of training after adding LORA weights hardly change this assignment in the further course of training and can therefore be hidden for optimizing the training. In order to speed up training, the search space is therefore already pruned during training by removing operations that are allocated a low weight. For this purpose, a new separate variable pᵢ is preferably introduced for each operation, which indicates whether the operation i is still part of the search space, i.e., whether it has not yet been pruned. For each operation, pᵢ=1 is initialized. Afterwards, a modification of the calculation of an edge is preferably carried out as follows:

$$y = {\sum }_{i} \frac{{p}_{i} {e}^{{α}_{i}}}{{\sum }_{j} {p}_{j} {e}^{{α}_{j}}} {o}_{i} ( x )$$

In a further aspect of the present invention, it is provided that operations are pruned from the supermodel if the weights of the LORA modules fall below a predetermined threshold value after applying a softmax function, or if the weights of the LORA modules fall below another function-dependent threshold value.

Pruning is preferably achieved by the following steps: For each edge in the supermodel, in case the edge is to be pruned, k operations oᵢ with the lowest architecture weights αᵢ from the supernetwork are removed by setting the relevant pᵢ=0. The decision as to whether to prune an edge can be made based on one or a combination of the following criteria. For example, pruning can be carried out at predefined training epochs, e.g., after epochs 20, 40, and 80. Pruning can also be carried out based on the architecture weights αi. Pruning can be carried out if the following applies:

$$softmax ( {α}_{i} ) < \frac{δ}{n}$$

wherein δ is a predefined absolute threshold value, e.g., δ=0.2, and n is the number of operations still comprised in the edge.

Alternatively or additionally, pruning can be carried out if the following applies:

$${e}^{{α}_{i}} < δ \cdot {max}_{j} {e}^{{α}_{j}}$$

with a predefined relative threshold value δ, e.g., δ=0.2.

In a further aspect of the present invention, a control unit, in particular configured as an embedded system, is also provided, which is comprised in a vehicle with an autonomous driving function and/or a robotic system and/or an industrial machine, and on which the partial model provided can be executed with reduced network dimension in a computing power-optimized and memory space-optimized manner.

The method of the present invention can be used in machine learning models in the field of autonomous driving. For example, it must be ensured that an automated vehicle does not collide with pedestrians. Based on semantic segmentation, a computer calculates depth information of all pedestrians, calculates a trajectory around these pedestrians and controls the vehicle so that it follows this trajectory so closely that it does not hit any pedestrians. This applies to any mobile robot, in order to avoid people who might get in its way.

In a further aspect of the present invention, a computer program having program code is provided for executing at least parts of the method of the present invention in one of its aspects when the computer program is executed on a computer. In other words, a computer program (product) comprising instructions which, when the program is executed by a computer, cause the computer to execute the method of the present invention/the steps of the method of the present invention in one of its aspects.

In a further aspect of the present invention, a computer-readable data carrier having program code of a computer program is proposed for carrying out at least parts of the method of the present invention in one of its aspects when the computer program is executed on a computer. In other words, the present invention relates to a computer-readable (memory) medium comprising instructions which, when executed by a computer, cause the computer to carry out the method of the present invention/the steps of the method of the present invention in one of its aspects.

The described embodiments and developments of the present invention can be combined with one another as desired.

Further possible embodiments, developments and implementations of the present invention also include combinations not explicitly mentioned of features of the present invention described above or in the following relating to the exemplary embodiments.

### BRIEF DESCRIPTION OF THE DRAWINGS

The figures are intended to impart further understanding of the embodiments of the present invention. They illustrate embodiments and, in connection with the description, serve to explain principles and concepts of the present invention.

Other embodiments of the present invention and many of the mentioned advantages are apparent from the figures. The illustrated elements of the figures are not necessarily shown to scale relative to one another.

FIG. 1 is a schematic flow chart of an exemplary embodiment of the method of the present invention.

FIG. 2 is a schematic representation of a NAS using DARTS.

### DETAILED DESCRIPTION OF EXAMPLE EMBODIMENTS

In the figures, identical reference signs denote identical or functionally identical elements, parts or components, unless stated otherwise.

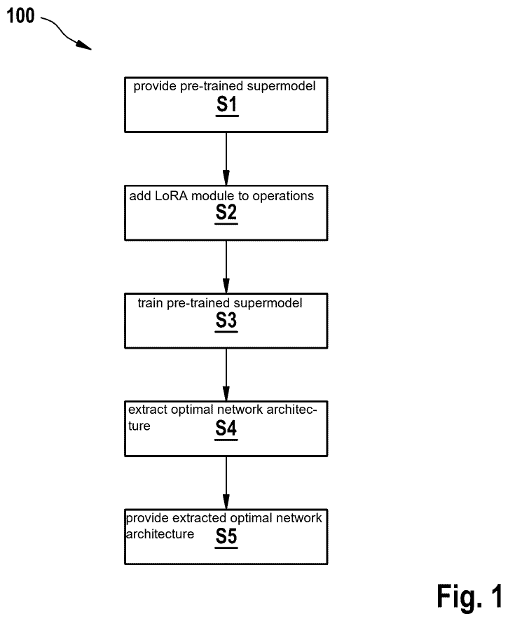

FIG. 1 is a schematic flow chart of a method for extracting an optimal network architecture for solving a target task.

In any embodiment, the method can be carried out, at least in part, by a device 100, which for this purpose can comprise multiple components not shown in more detail, for example one or more provisioning units and/or at least one evaluation and computing unit. It is self-evident that the provisioning unit can be designed together with the evaluation and computing unit or can be different therefrom. Furthermore, the device 100, which can be part of a system, can comprise a storage unit and/or an output unit and/or a display unit and/or an input unit.

The computer-implemented method comprises at least the following steps:

In a step S1, a supermodel pre-trained on the basis of labeled training data is provided for solving a target task, wherein the supermodel comprises a plurality of pre-trained operations.

In a step S2, at least one LORA module is added to at least one of the operations of the supermodel, wherein the LORA modules in each case comprise trainable weights, wherein the at least one of the operations of the supermodel preferably remains unchanged or is frozen during the addition of the weights.

In a step S3, the pre-trained supermodel is trained by training the respective weights of the relevant LORA module and the at least one of the operations in particular until a certain training criterion is reached.

In a step S4, an optimal network architecture for solving the target task is extracted from the trained supermodel on the basis of the trained weights of the LORA modules.

In a step S5, the extracted optimal network architecture is provided for solving the target task.

FIG. 2 shows a schematic representation of a Neural Architecture Search (NAS) using the conventional DARTS approach. An edge of a supernetwork 200 with an input 202 and an output 204 is shown by way of example, wherein within the supernetwork 200 different operations 206, 208, 210 are available in order to move from the input 202 to the output 204. In the present case, the individual operations 206, 208, 210 or o₁ to oₙ are weighted regarding their relevant importance in participating in the generation of the output 204 by respective weights 205 or a₁ to aₙ, which are incorporated into a softmax function 212. The softmax function 212 serves to normalize the weights 205 in such a way that their total sum equals 1. For generating the output 204, the outputs of the operations 206, 208, 210 are summed according to their weighting.

1-10. (canceled)

11. A method for extracting an optimal network architecture for solving a target task, the method comprising the following steps:
providing a supermodel pre-trained based on labeled training data for solving the target task, wherein the supermodel includes a plurality of pre-trained operations, each of which can be assigned at least one architecture weight;
adding at least one LoRA module to at least one respective one of the operations of the supermodel, wherein each of the at least one LoRA module includes respective trainable weights, wherein the at least one of the operations of the supermodel remains unchanged or is frozen during addition of the trainable weights;
training the pre-trained supermodel by training the respective weights of each of the at least one LORA module and the at least one of the operations, until a certain training criterion is reached;
extracting an optimal network architecture for solving the target task from the trained supermodel based on the trained architecture weights; and
providing the extracted optimal network architecture for solving the target task.

12. The method according to claim 11, wherein the operations of the supermodel are pre-trained until a predetermined termination criterion is reached.

13. The method according to claim 11, wherein the extracting of the optimal network architecture from the trained supermodel based on the trained architecture weights includes selecting the operations that are allocated the highest architecture weights.

14. The method according to claim 11, wherein the provided, extracted optimal network architecture is retrained based on the labeled training data to solve the target task.

15. The method according to claim 11, wherein after the extracting of the optimal network architecture, the at least one LoRA modules and the respective operations are combined.

16. The method according to claim 11, wherein after training the weights of the at least one LoRA module, a pruning of operations of the supermodel is carried out based on the weights of the at least one LoRA module.

17. The method according to claim 16, wherein operations are pruned from the supermodel when the weights of the at least one LoRA module fall below a predetermined threshold value after applying a softmax function, or when the weights of the at least one LoRA module fall below another function-dependent threshold value.

18. A non-transitory computer-readable data carrier on which is stored a computer program for extracting an optimal network architecture for solving a target task, the computer program, when executed by a computer, causing the computer to perform the following steps:
providing a supermodel pre-trained based on labeled training data for solving the target task, wherein the supermodel includes a plurality of pre-trained operations, each of which can be assigned at least one architecture weight;
adding at least one LoRA module to at least one respective one of the operations of the supermodel, wherein each of the at least one LoRA module includes respective trainable weights, wherein the at least one of the operations of the supermodel remains unchanged or is frozen during addition of the trainable weights;
training the pre-trained supermodel by training the respective weights of each of the at least one LoRA module and the at least one of the operations, until a certain training criterion is reached;
extracting an optimal network architecture for solving the target task from the trained supermodel based on the trained architecture weights; and
providing the extracted optimal network architecture for solving the target task.

19. A device configured to extract an optimal network architecture for solving a target task, wherein the device comprises an evaluation and computing unit that is configured to carry out the following steps:
providing a supermodel pre-trained based on labeled training data for solving the target task, wherein the supermodel includes a plurality of pre-trained operations, each of which can be assigned at least one architecture weight;
adding at least one LoRA module to at least one of the operations of the supermodel, wherein each of the at least one LoRA module includes respective trainable weights, wherein the at least one of the operations of the supermodel remains unchanged or is frozen during addition of the respective trainable weights;
training the pre-trained supermodel by training the respective weights of the at least one LoRA module and the at least one of the operations until a certain training criterion is reached;
extracting an optimal network architecture for solving the target task from the trained supermodel based on the trained architecture weights; and
providing the extracted optimal network architecture for solving the target task.
